(19) United States
(12) Patent Application Publication
(10) Pub. No.: US 2002/0123404 A1
(43) Pub. Date: Sep. 5, 2002

(54) Silent chain

(76) Inventor: Isamu Okabe, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/085,281

(22) Filed: Feb. 28, 2002

(30) Foreign Application Priority Data
Mar. 5, 2001 (JP) 60800/2001

(51) Int. Cl. F16G 13/04; F16G 13/02

(52) U.S. Cl. 474/212; 474/213; 474/229

(57) ABSTRACT

In an inner link plate, which forms a link assembly of a silent chain, positions K, L, M and N where the respective distances between a bush hole, and the outside surface portion, the inside surface portion, the back surface portion and the shoulder portion reach the shortest distances are located in the vicinity of a hypothetical circle substantially concentric with the bush hole, and at the same time the shortest distances k, 1, m and n in the respective positions K, L, M and N are formed to be the plate thickness t of the inner link plate or more.

### BACKGROUND OF THE INVENTION

The present invention relates to a silent chain used for a power transmission such as a timing drive of automobiles or motorcycles or a chain drive of general purpose engines, diesel engines or industrial machines or the like, and more specifically to a silent chain preferably used as a timing chain for engines.

As one example of a conventional silent chain a bush-type silent chain 1 is shown in FIGS. 4(A) and 4(B). In this silent chain 1, a guide plate 2, a link assembly 3 and an intermediate link plate 6 are disposed in a width direction of the chain, as shown in FIGS. 4(A) and 4(B), and the respective members are combined so that they are shifted in the longitudinal direction of the chain, that is, they are combined with each other in a state of interlaced fingers. The members are articulately connected with each other with connecting pins 7.

The guide plate 2 includes no meshing teeth but a pair of pin holes 2a as shown in FIG. 5. The link assembly 3 comprises two inner link plates 4 each having a pair of teeth 4a, which meshes with the teeth of a sprocket, and a pair of bush holes 4b, and two, i.e. a pair of bushes 5 each press-fitted into the bush hole 4b, as shown in FIGS. 6(A) and 6(B). In the link assembly 3, the two inner link plates 4 are integrally connected and fixed to each other with the two bushes 5. Further, the intermediate link plate 6 includes a pair of teeth 6a, which meshes with the teeth of a sprocket, and a pair of pin holes 6b, as shown in FIG. 7.

In the inner link plate 4 are formed, as shown in FIG. 6(A) and FIG. 8, a pair of teeth 4a each comprised of the outside surface portion 4c and the inside surface portion 4d, a pair of bush holes 4b, into each of which the bush 5 is press-fitted and fixed, a back surface portion 4e formed on the opposite side to the side where the pair of teeth 4a is formed, and a pair of shoulder portions 4f each of which makes connections between the outside surface portion 4c and the back surface portion 4e. It is noted that one-dotted chain line P in FIG. 8 is a pitch line, which makes connections between the centers of the pair of bush holes 4b.

Further, more specifically, in the silent chain 1 two intermediate link plates 6 are disposed in the center in a width direction of the chain, and the link assemblies 3 are disposed on both outer sides of the intermediate link plates 6, and the guide plates 2 are disposed on both the outermost sides as shown in FIG. 4(A). They are combined with each other in a state of interlaced fingers while being shifted from each other and articulately connected to each other with the connecting pins 7. In this case, in the guide plates 2 on the both outermost sides in the silent chain 1 the connecting pin 7 is press-fitted into and fixed to the pin hole 2a, and in the intermediate link plates 6 the connecting pin 7 is fitted into the pin hole 6b with a play or press-fitted and fixed into the pin hole 6b.

In the inner link plates 4, which form the link assembly 3, the bush 5 is press-fitted into and fixed to the bush hole 4b. Thus, a one-size larger bush hole 4b as compared with the pin hole 6b in the intermediate link plate 6 is formed in the inner link plate 4. As a result a distance between the bush hole 4b and the adjacent outer side portion in the inner link plate 4 becomes smaller entirely than in the intermediate link plate 6. In this case, the bush hole 4b and the pin hole 6b are disposed concentrically, and as shown in FIG. 8, the shortest distance k′ between the bush hole 4b and the outside surface portion 4c, the shortest distance 1′ between the bush hole 4b and the inside surface portion 4d, the shortest distance m′ between the bush hole 4b and the back surface portion 4e, and the shortest distance n′ between the bush hole 4b and the shoulder portion 4f becomes comparatively small.

The inner link plate 4 is usually made of a metallic plate such as a steel sheet, a band steel or the like by press punching. In this case, the metallic plate is first punched in an outside shape of the inner link plate 4, and then, the bush holes 4b are punched. Alternatively, the bush holes 4b are first punched from the metallic plate and then the obtained metallic plate is punched into an outside shape of the inner link plate 4. However, in any case, a deformation due to the press punching is easy to occur in a portion having a small distance between the outside surface portion of the inner link plate 4 and the bush hole 4b. Thus, a roundness of the bush hole 4b itself is deteriorated.

Further, when the bush 5 is press-fitted into the bush hole 4b in the inner link plate 4, the inner link plate is deformed in its narrow portion and accordingly strain is generated on the inner diameter of the press-fitted bush 5. In this case, when the bush 5 is press-fitted into the bush hole 4b whose roundness was deteriorated as mentioned above, strain is further significantly generated on the inner diameter of the bush 5 under the influence of the strain. That is, as shown in FIG. 8, the strains of the inner diameter of the bush 5 are generated near the positions K′, L′, M′, and N′ where the distances between the bush hole 4b, and the outside surface portion 4c and inside surface portion 4d of the teeth 4a of the inner link plate, the back surface portion 4e and shoulder portion 4f are the shortest, and the roundness of the inner diameter of the bush is deteriorated. Further, when a balance between the shortest distances k′, 1′, m′ and n′ is bad, a degree of deformation in the inner diameter of the bush press-fitted into the bush hole becomes nonuniform and the roundness of the inner diameter of the bush 5 is deteriorated. Vertical accuracy of the bush 5 with respect to the inner link plate 4 may also be decreased. In this case, to prevent the deformation in the inner diameter of the bush 5, increasing the pipe thickness of the bush is also conceived. However, there are limits in a relationship between the strength (diameter) of the connecting pin and the size of the inner link plate and the like.

Since attention has not been directed to a relationship between the shortest distance and the plate thickness in the inner link plate, a position where the shortest distance is the plate thickness or more and a position where the shortest distance is under the plate thickness may be mixed or any one of the shortest distances may be too small as compared with a plate thickness t of the inner link plate. Thus, as described above, the roundness of the inner diameter of the bush is deteriorated, and the inner link plate is deformed at a narrow portion during press-fitting of the bush into the bush hole and the narrow portion may be broken.

As described above, when the roundness of the inner diameter of the bush press-fitted into the bush hole is deteriorated or the vertical accuracy of the bush with respect to the inner link plate is decreased, in a case where the link assembly is used while being incorporated into the chain, the interfacial pressure between a surface of the connecting pin and an inner periphery of the bush becomes nonuniform or the connecting pin makes contact with the inner periphery of the bush on one side. Thus, wear of the connecting pin and bush is accelerated and accordingly a wear elongation of the chain is also accelerated.

### SUMMARY OF THE INVENTION

It is, accordingly, a general object of the present invention to overcome the problems associated with the above-mentioned conventional silent chain.

A more specific object of the present invention is to provide a silent chain in which wear of a connecting pin and a bush can be suppressed and a wear elongation of the chain can be suppressed.

According to one aspect of the present invention, there is provided a silent chain for use in a power transmission comprising: a link assembly including at least two inner link plates each having a pair of teeth and bush holes and connected and fixed to each other with said pair of bushes press-fitted into said respective bush holes, an intermediate or outer link plate having a pair of teeth and bush holes; and a guide plate having a pair of bush holes; said link assembly, said intermediate or outer link plate, and said guide plate being combined with each other, and articulately connected with a connecting means, wherein said inner link plate has said pair of teeth each having an outside surface portion and an inside surface portion, a back surface portion formed on the opposite side to the side of the pair of teeth, and a shoulder portion, which makes connection between said outside surface portion and said back surface portion, and if a position on said outside surface portion where a distance between said bush hole and said outside surface portion reaches the shortest distance k is defined as K, a position on said inside surface portion where a distance between said bush hole and said inside surface portion reaches the shortest distance 1 is defined as L, a position on said back surface portion where a distance between said bush hole and said back surface portion reaches the shortest distance m is defined as M, and a position on said shoulder portion where a distance between said bush hole and said shoulder portion reaches the shortest distance n is defined as N, each of said shortest distances k, 1, m and n is the plate thickness of said inner link plate or more, and the respective positions K, L, M and N are located in the vicinity of a hypothetical circle substantially concentric with said bush hole.

In the silent chain according to the present invention, it is preferable that the shoulder portion of the inner link plate is formed of an arc concentric with the bush hole.

Alternatively, the shoulder portion of said inner link plate may be formed of an arc of a composite round curves including an arc concentric with the bush hole.

Further, in the silent chain according to the present invention, a difference between a maximum distance in each said shortest distance k, 1, m or n, and a minimum distance therein, is preferably 30% or less of the minimum shortest distance.

The silent chain may comprise two the intermediate link plates disposed in the center in a width direction of said silent chain, two the link assemblies disposed on both outer sides of the intermediate links, and two the guide plates disposed on both outermost sides of the link assemblies.

Alternatively, the silent chain may comprise the guide plate disposed in the center in a width direction of the silent chain, two the link assemblies disposed on both outer sides of the guide plate, and two the outer guide plates disposed on both outermost sides of the two link plates.

According to the present invention, when the bush is press-fitted into the bush hole of the inner link plate, a deterioration of roundness of an inner diameter of the bush can be prevented, and at the same time the reduction in vertical accuracy with respect to the inner link plate of the bush can be prevented. As a result, wear of the connecting pin and bush can be suppressed and the wear elongation of the chain can be suppressed.

### BRIEF DESCRIPTION OF THE DRAWINGS

Preferred embodiments of the present invention will now be described in detail, by way of example only, with reference to the accompanying drawings, in which:

FIG. 1 is a side view of an inner link plate of Embodiment 1 according to the present invention;

FIGS. 2(A) and 2(B) show an inner link plate of Embodiment 2 according to the present invention, particularly, FIG. 2(A) is a side view thereof and FIG. 2(B) is a cross-sectional view thereof;

FIG. 3 is a side view of an inner link plate of Embodiment 3 according to the present invention;

FIG. 4 shows a conventional silent chain, particularly, FIG. 4(A) is a plan view thereof including a partial cross-sectional view, and FIG. 4(B) is a side view thereof;

FIG. 5 is a side view of a conventional guide plate;

FIGS. 6(A) and 6(B) show a conventional link assembly, particularly FIG. 6(A) is a side view thereof and FIG. 6(B) is a cross-sectional view thereof;

FIG. 7 is a side view of a conventional intermediate link plate;

FIG. 8 is a side view of a conventional inner link plate; and

FIG. 9 is a graph showing comparison test results of the elongation of silent chains.

### DETAILED DESCRIPTION OF THE PREFERRED EMBODIMENTS

The following description is merely exemplary in nature and is in no way intended to limit the invention or its application or uses.

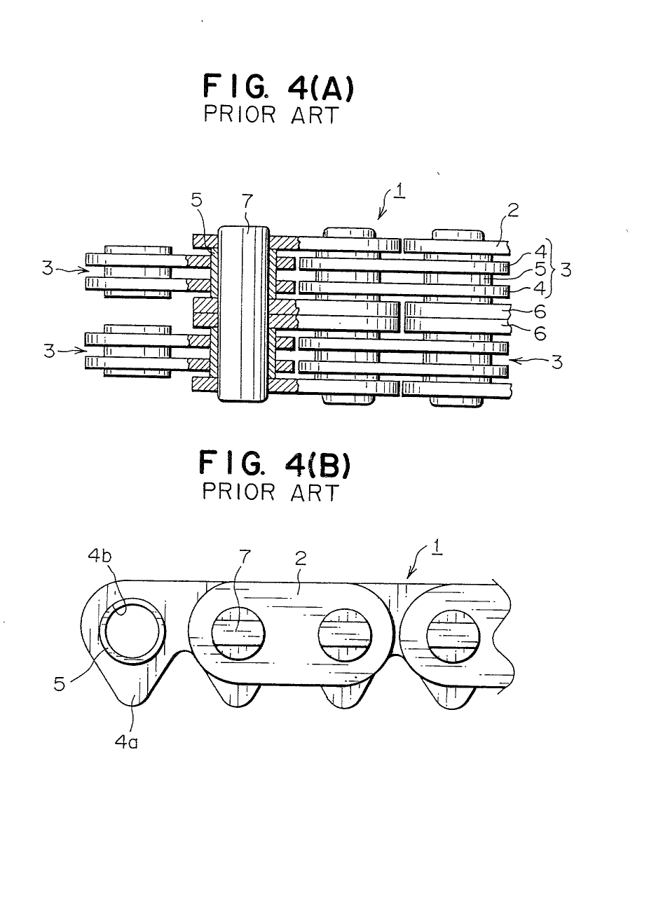

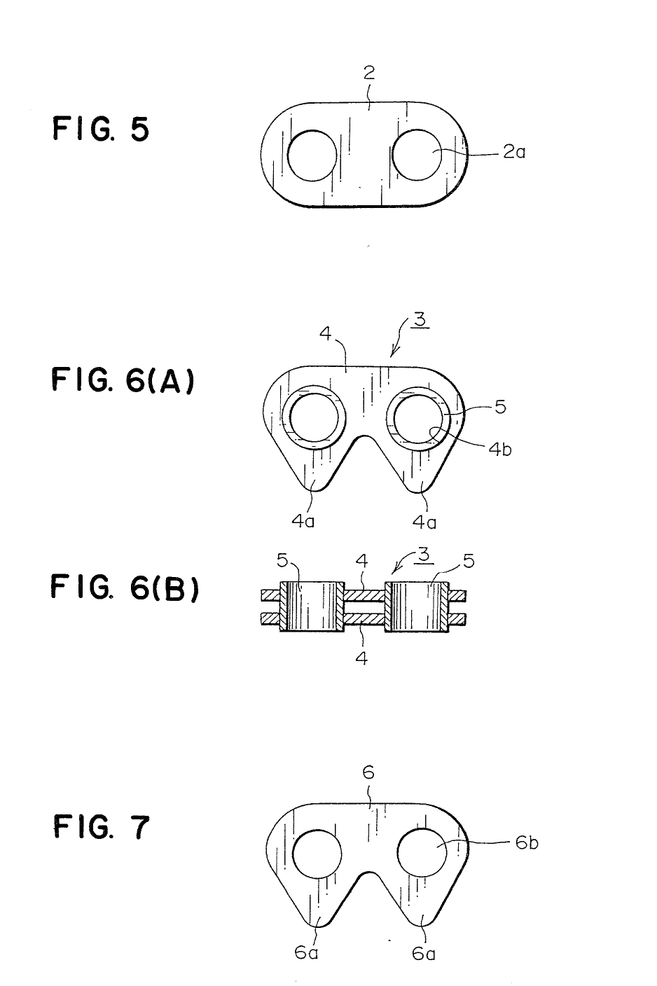

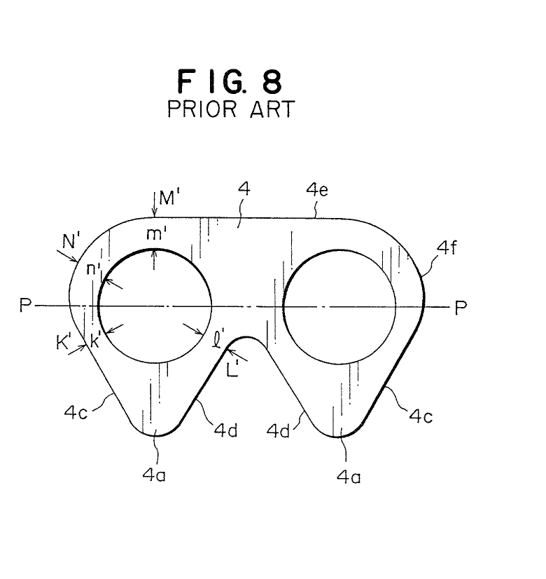

Embodiment 1 according to the present invention will be described with reference to FIG. 1. A silent chain of the present invention is substantially the same as a conventional silent chain shown in FIGS. 4(A) and 4(B) except that only a link assembly of the present invention is different from a conventional link assembly. Thus, the drawing of the whole of a silent chain and an explanation of a concrete structure thereof will be omitted and the same members in the silent chain of the present invention as in the conventional silent chain are denoted as the same reference numerals and the description thereof will be omitted.

The silent chain in Embodiment 1 comprises, as in said conventional silent chain shown in FIGS. 4(A) and 4(B), two intermediate link plates 6 disposed in the center in the width direction of the chain, two link assemblies 3 respectively disposed on the both outer sides of the intermediate link plates 6 and two guide plates 2 respectively disposed on the outermost sides of the link assemblies 3. The members are combined in a state of interlaced fingers and articulately connected to each other with a connecting pin 7. The guide plate 2 includes no meshing teeth but a pair of pin holes 2a. Further, the intermediate link plate 6 includes a pair of teeth 6a, which meshes with the teeth of a sprocket, and a pair of pin holes 6b.

The link assembly 3 comprises, as in said conventional link assembly, two inner link plates each having a pair of teeth, which meshes with the teeth of a sprocket, and a pair of bush holes, and two, i.e. a pair of bushes 5 each press-fitted into the bush hole. In the link assembly 3, the two inner link plates are integrally connected and fixed to each other with the two bushes 5.

FIG. 1 shows an inner link plate 14, which forms a link assembly according to the present invention. In the inner link plate 14 are formed, as shown in FIG. 1, a pair of teeth 14a each having the outside surface portion 14c and the inside surface portion 14d, a pair of bush holes 14b, into each of which the bush 5 is press-fitted and fixed, a back surface portion 14e formed on the opposite side to the side where the pair of teeth 14a was formed, and a pair of shoulder portions 14f each of which makes connections between the outside surface portion 14c and the back surface portion 14e. Further, this shoulder portion 14f is formed in an arc, which is substantially concentric with the bush hole 14b.

In FIG. 1, K is a position in the outside surface portion 14c where the distance between the bush hole 14b and the outside surface portion 14c reaches the shortest distance k, L is a position in the inside surface portion 14d where the distance between the bush hole 14b and the inside surface portion 14d reaches the shortest distance 1, M is a position in the back surface portion 14e where the distance between the bush hole 14b and the back surface portion 14e reaches the shortest distance m, and N is a position in the shoulder portion 14f where the distance between the bush hole 14b and the shoulder portion 14f reaches the shortest distance n. These respective positions K, L, M and N are located in the vicinity of a hypothetical circle 14R, which is substantially concentric with the bush hole 14b, and the distances k, 1, m and n are the same, that is k=1=m=n. Further, every one of the respective shortest distances k, 1, m and n has a plate thickness t of the inner link plate or more.

When the inner link plate 14 is formed in such a manner as described above, the bush 5 press-fitted into the bush hole 14b has a substantially uniform degree of deformation in the inner diameter thereof. Thus, a roundness of the inner diameter of the bush is not deteriorated. Accordingly, a biased contact between the connecting pin and the inner periphery of the bush is prevented and at the same time, an interfacial pressure between the connecting pin and the inner periphery of the bush becomes uniform, so that wear of the connecting pin and bush can be prevented. As a result, the silent chain including the link assembly comprised of the inner link plate 14 is prevented from the wear elongation.

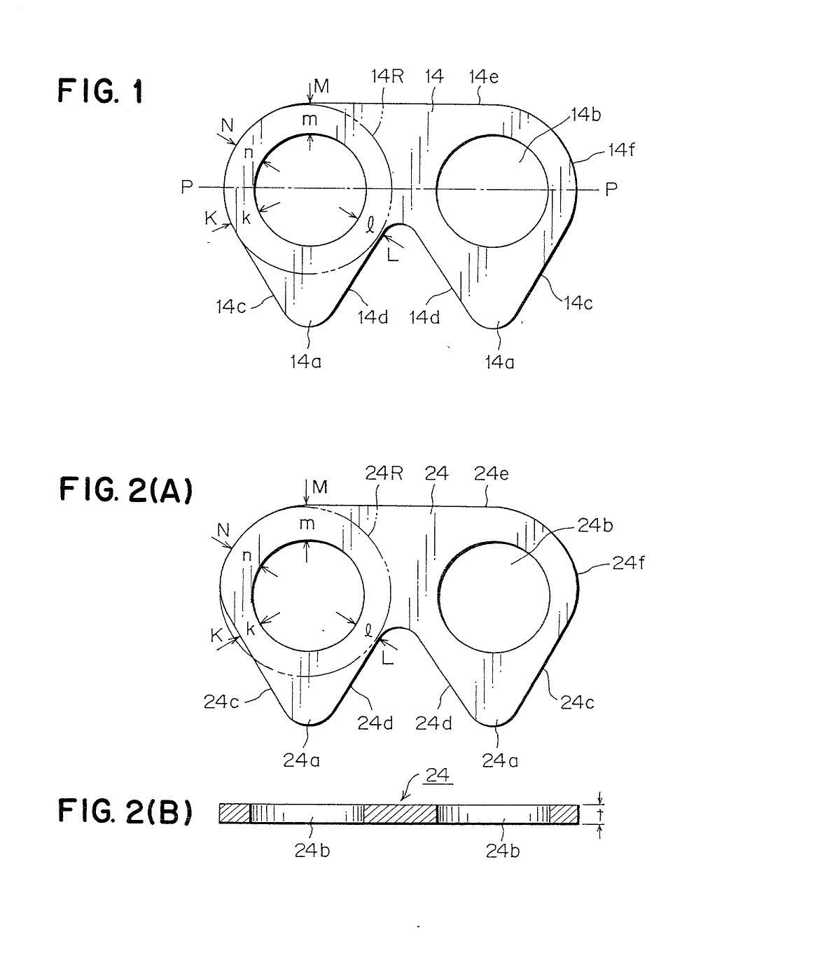

Embodiment 2 of the present invention will be described with reference to FIGS. 2(A) and 2(B). The silent chain in Embodiment 2 comprises, as in said silent chain of Embodiment 1, two intermediate link plates 6, two link assemblies 3 respectively disposed on the both outer sides of the intermediate link plates 6 and two guide plates 2 respectively disposed on the both outermost sides of the link assemblies 3. The members are combined in a state of interlaced fingers and articulately connected to each other with a connecting pin 7. The link assembly 3 comprises, as in said conventional link assembly, two inner link plates each having a pair of teeth, which meshes with the teeth of a sprocket, and a pair of bush holes, and two, i.e. a pair of bushes 5 each press-fitted into the bush hole. In the link assembly 3, the two inner link plates are integrally connected and fixed to each other with the two bushes 5.

FIGS. 2(A) and 2(B) show an inner link plate 24, which forms a link assembly according to Embodiment 2 of the present invention. In the inner link plate 24 are formed, as in Embodiment 1, a pair of teeth 24a each having the outside surface portion 24c and the inside surface portion 24d, a pair of bush holes 24b, into each of which the bush 5 is press-fitted and fixed, a back surface portion 24e formed on the opposite side to the side where the pair of teeth 24a was formed, and a pair of shoulder portions 24f each of which makes connections between the outside surface portion 24c and the back surface portion 24e.

In FIG. 2, K is a position in the outside surface portion 24c where the distance between the bush hole 24b and the outside surface portion 24c reaches the shortest distance k, L is a position in the inside surface portion 24d where the distance between the bush hole 24b and the inside surface portion 24d reaches the shortest distance 1, M is a position in the back surface portion 24e where the distance between the bush hole 24b and the back surface portion 24e reaches the shortest distance m, and N is a position in the shoulder portion 24f where the distance between the bush hole 24b and the shoulder portion 24f reaches the shortest distance n. These respective positions K, L, M and N are located in the vicinity of a hypothetical circle 24R, which is substantially concentric with the bush hole 24b. Further, every one of the respective shortest distances k, 1, m and n has a plate thickness t of the inner link plate or more.

Here, the fact that the respective positions K, L, M and N are located in the vicinity of the hypothetical circle 24R, which is substantially concentric with the bush hole 24b, means that the respective shortest distances k, 1, m and n are substantially the same, that is, k≈1≈m≈n. If only the wear resistance of the silent chain is conceived, it is preferable that the respective shortest distances k, 1, m and n in the inner link plate are substantially the same as in Embodiment 1. However, if the strength of the silent chain and the engagement of the inner link plate with the teeth of the sprocket are conceived, the respective shortest distances may have to be slightly differentiated from each other. If the difference between a maximum in the respective shortest distances k, 1, m and n, and a minimum therein is 30% or less with respect to the minimum distance, a degree of deformation in the inner diameter of the press-fitted bush becomes comparatively uniform. However, if the difference exceeds 50%, the degree of deformation in the inner diameter of the press-fitted bush becomes too nonuniform. Therefore, it is allowable that the difference between a maximum in the respective shortest distances k, 1, m and n, and a minimum therein is 30% or less.

When the inner link plate 24 is formed in such a manner as described above, the bush 5 press-fitted into the bush hole 24b has a substantially uniform degree of deformation in the inner diameter thereof. Thus, a roundness of the inner diameter of the bush is not deteriorated. Accordingly, a biased contact between the connecting pin and the inner periphery of the bush is prevented and at the same time, an interfacial pressure between the connecting pin and the inner periphery of the bush becomes uniform, so that wear of the connecting pin and bush can be prevented. As a result, the silent chain including the link assembly comprised of the inner link plate 24 is prevented from the wear elongation.

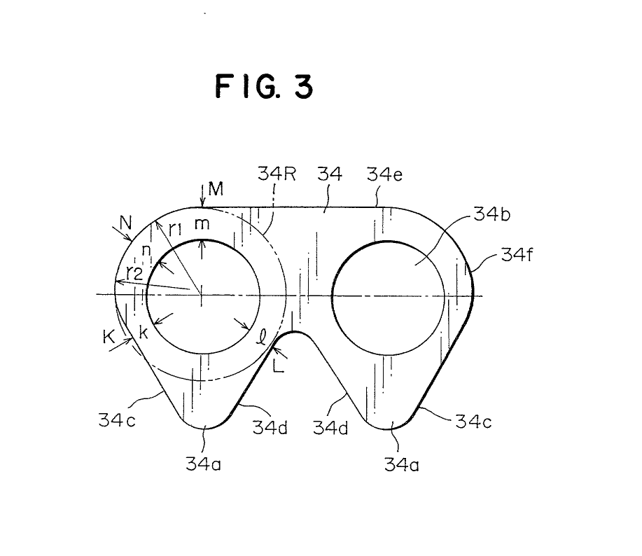

Embodiment 3 of the present invention will be described with reference to FIG. 3. The silent chain in Embodiment 3 comprises, as in said silent chain of Embodiment 1, two intermediate link plates 6, two link assemblies 3 respectively disposed on the both outer sides of the intermediate link plates 6 and two guide plates 2 respectively disposed on the both outermost sides of the link assemblies 3. The members are combined in a state of interlaced fingers and articulately connected to each other with a connecting pin 7. The link assembly 3 comprises, as in said conventional link assembly, two inner link plates each having a pair of teeth, which meshes with the teeth of a sprocket, and a pair of bush holes, and two, i.e. a pair of bushes 5 each press-fitted into the bush hole. In the link assembly 3, the two inner link plates are integrally connected and fixed to each other with the two bushes 5.

FIG. 3 shows an inner link plate 34, which forms a link assembly according to Embodiment 3 of the present invention. In the inner link plate 34 are formed, as in Embodiment 2, a pair of teeth 34a each having the outside surface portion 34c and the inside surface portion 34d, a pair of bush holes 34b, into each of which the bush 5 is press-fitted and fixed, a back surface portion 34e formed on the opposite side to the side where the pair of teeth 34a was formed, and a pair of shoulder portions 34f each of which makes connections between the outside surface portion 34c and the back surface portion 34e. The shoulder portion 34f is formed of a composite round curve. That is a portion, which continues to the back surface portion 34e is formed of a curve of r1, which is concentric with the bush hole 34b, and a portion, which continues to the outside surface portion 34c is formed of a curve of r2, whose center is slightly shifted from the center of the bush hole 34b.

In FIG. 3, K is a position in the outside surface portion 34c where the distance between the bush hole 34b and the outside surface portion 34c reaches the shortest distance k, L is a position in the inside surface portion 34d where the distance between the bush hole 34b and the inside surface portion 34d reaches the shortest distance 1, M is a position in the back surface portion 34e where the distance between the bush hole 34b and the back surface portion 34e reaches the shortest distance m, and N is a position in the shoulder portion 34f where the distance between the bush hole 34b and the shoulder portion 34f reaches the shortest distance n. These respective portions K, L, M and N are dotted in the vicinity of a hypothetical circle 34R, which is substantially concentric with the bush hole 34b. Further, every one of the respective shortest distances k, 1, m and n has a plate thickness t of the inner link plate or more.

The respective shortest distances k, 1, m and n has a relation of k≈1≈m≈n≧t. The difference between a maximum in the respective shortest distances k, 1, m and n, and a minimum therein is 30% or less with respect to the minimum distance.

When the inner link plate 34 is formed in such a manner as described above, the bush 5 press-fitted into the bush hole 34b has a substantially uniform degree of deformation in the inner diameter thereof. Thus, a roundness of the inner diameter of the bush is not deteriorated. Accordingly, a biased contact between the connecting pin and the inner periphery of the bush is prevented and at the same time, an interfacial pressure between the connecting pin and the inner periphery of the bush becomes uniform, so that wear of the connecting pin and bush can be prevented. As a result, the silent chain including the link assembly comprised of the inner link plate 34 is prevented from the wear elongation.

As described above, Embodiments 1 to 3 were explained. However, as another embodiment the link assembly may comprise three or more link plates instead of two link plates. That is, the link assembly preferably comprises at least two link plates. Further, in the silent chain according to the present invention, in stead of disposing two link assemblies in the width direction of the chain three or more link assemblies may be disposed therein. Further, one or a plurality of intermediate link plate(s) may be disposed, and the intermediate link plates may be disposed at a plurality of positions. Furthermore, the shoulder portion of the inner link plate is formed not only by an arc section concentric with the bush hole but also by a linear section.

Further, another type of the silent chain may comprises a guide plate 2 inside in the width direction of the chain (that is center), link assemblies 3 disposed on the both sides of the guide plate 2 respectively, and outer link plates 6 disposed on the outermost sides of the respective link assemblies 3, while the members are combined to each other with a connecting pin 7 in a state of interlaced fingers. It is noted that when the silent chain is used as a transmission device with the silent chain wound around a sprocket, a sprocket having an annular concave groove into the outer periphery of which the guide plate can be inserted, in the central section.

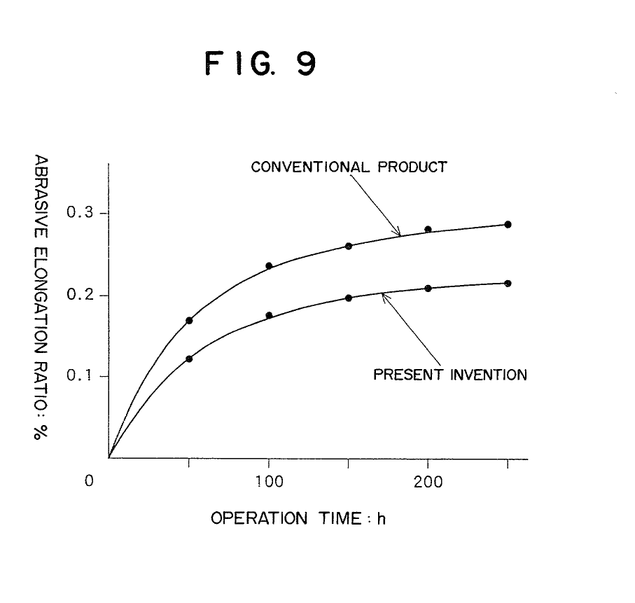

Comparison test results between the silent chain according to the present invention (the product of the present invention) and the conventional silent chain (the conventional product) are shown in FIG. 9. The tested silent chains are those having a structure shown in FIG. 7. The silent chain of the present invention (corresponding to Embodiment 2) is different from the conventional silent chain in only the inner link plate, which forms the link assembly.

In the inner link plate, the intermediate link plate, and the guide plate in each of the silent chains, the pitch between the pin hole and bush hole; about 9.525 mm, the diameter of the connecting pin; about 4.5 mm or less, the length of the bush; about 4.5 mm, the bush plate thickness; about 0.7 mm, the bush diameter (inner diameter); 4.5 mm or more, and the clearance C; about 0.1 mm.

In the inner link plate, which comprises the link assembly, in the product of the present invention, k; about 1.3 mm, 1; about 1.5 mm, m; about 1. 65 mm, n; about 1.6 mm, and the plate thickness t; about 1.3 mm, that is the maximum of the shortest distance m is about 1.65 mm and the minimum thereof k is about 1.3 mm. A percentage of the difference between m and k, that is, (m−k) to k; [(1.65−1.3)÷1.3]×100=27%. In the conventional product, k; about 1.2 mm, 1; about 1.5 mm, m; about 1.7 mm, n; about 1.6 mm, and the plate thickness t; about 1.3 mm, that is the maximum of the shortest distance m is about 1.7 mm and the minimum thereof k is about 1.2 mm. A percentage of the difference between m and k, that is, (m−k) to k; [(1.7−1.2)÷1.2]×100=383%.

The test conditions are as follows, that is the sprocket; 21NT×42NT, the chain speed; about 19 m/s, the chain tension; about 1.8 kN. The chain lengths were measured with time after running the chain while lubricating it. The elongation ratio of the chain is a ratio of a chain length to the elongated length of the chain after the test. As can be seen from FIG. 9, the silent chains of the present invention are significantly improved in the elongation ratio as compared with the conventional silent chains.

According to the present invention, in a case where the bush has been press-fitted into the bush hole of the inner link plate, the deterioration of roundness of the inner diameter of the bush can be prevented, and at the same time the reduction of vertical accuracy with respect to the inner link plate of the bush can be prevented. As a result, the wear of the pin and bush can be suppressed and the wear elongation of the chain can be suppressed. Obviously, various minor changes and modifications of the present invention are possible in the light of the above teaching. It is therefore to be understood that within the scope of the appended claims, the present invention may be practiced otherwise than as specifically described.

What is claimed is:

1. A silent chain for use in a power transmission comprising:
a link assembly including at least two inner link plates each having a pair of teeth and bush holes and connected and fixed to each other with said pair of bushes press-fitted into said respective bush holes,
an intermediate or outer link plate having a pair of teeth and bush holes; and
a guide plate having a pair of bush holes;
said link assembly, said intermediate or outer link plate, and said guide plate being combined with each other, and articulately connected with a connecting means,
wherein said inner link plate has said pair of teeth each having an outside surface portion and an inside surface portion, a back surface portion formed on the opposite side to the side of the pair of teeth, and a shoulder portion, which makes connection between said outside surface portion and said back surface portion, and if a position on said outside surface portion where a distance between said bush hole and said outside surface portion reaches the shortest distance k is defined as K, a position on said inside surface portion where a distance between said bush hole and said inside surface portion reaches the shortest distance l is defined as L, a position on said back surface portion where a distance between said bush hole and said back surface portion reaches the shortest distance m is defined as M, and a position on said shoulder portion where a distance between said bush hole and said shoulder portion reaches the shortest distance n is defined as N, each of said shortest distances k, l, m and n is the plate thickness of said inner link plate or more, and the respective positions K, L, M and N are located in the vicinity of a hypothetical circle substantially concentric with said bush hole.

2. The silent chain according to claim 1, wherein said shoulder portion of said inner link plate is formed of an arc concentric with said bush hole.

3. The silent chain according to claim 1, wherein said shoulder portion of said inner link plate is formed of an arc of a composite round curves including an arc concentric with said bush hole.

4. The silent chain according to any one of claims 1 to 3, wherein a difference between a maximum distance in each said shortest distance k, l, m or n, and a minimum distance therein, is 30% or less of the minimum shortest distance.

5. The silent chain according to claim 1, wherein said silent chain comprises two said intermediate link plates disposed in the center in a width direction of said silent chain, two said link assemblies disposed on both outer sides of said intermediate link plates, and two said guide plates disposed on both outermost sides of said link assemblies.

6. The silent chain according to claim 1, wherein said silent chain comprises said guide plate disposed in the center in a width direction of said silent chain, two said link assemblies disposed on both outer sides of said guide plate, and two said outer guide plates disposed on both outermost sides of said two link assemblies.
